(19) United States
(12) Patent Application Publication
(10) Pub. No.: US 2002/0116330 A1
(43) Pub. Date: Aug. 22, 2002

(54) Wireless communicating credit card

(76) Inventors: Aharon Zeev Hed, Nashua, NH (US); Richard Pavelle, Winchester, MA (US)

Correspondence Address: THE FIRM OF KARL F ROSS, 5676 RIVERDALE AVENUE, PO BOX 900, RIVERDALE (BRONX), NY, 10471-0900, US

(21) Appl. No.: 09/790,116

(22) Filed: Feb. 21, 2001

(51) Int. Cl. G06F 17/60

(52) U.S. Cl. 705/39; 235/379

(57) ABSTRACT

A financial transmission method utilizes smart cards with radiofrequency communication between the central station and the card so that the smart card is periodically or continuously updated as to account details which can be readily seen by a display on the card. The card, which otherwise has all of the size and dimensions and shape and embossability of a conventional credit card, debit card or ATM card also has the usual magnetic stripe-bearing information as to the card and the account to be debited or modified.

### FIELD OF THE INVENTION

The present invention relates to smart credit cards, and particularly to communicating credit cards capable of using a wireless network to update credit information and recent transactions carried on that card's account.

### BACKGROUND OF THE INVENTION

Credit cards and smart cards are well known in the prior art. Worldwide standards have been promulgated to facilitate the use of credit cards from various sources at various points of use. However, bearers of such credit cards, particularly those having a credit limit imposed thereon, are often faced with an embarrassing situation whereby their card is declined because the credit limit was reached. Furthermore, since many channels of distributions do not require the physical presence of the credit card, for instance when transactions are negotiated over the phone, fraudulent use of the card by third parties often occurs. When such unauthorized use of the card occurs, the card owner may not be able to ascertain such was the case until he receives his monthly statement. Many card users do not meticulously review their credit cards accounts on a monthly basis or even in a timely fashion, as well. In many cases, the credit card account is used by more than one member of a given household, creating situations whereby the current status of the account is not known by all users of the card. There is, therefore, a need to provide the card's owner with an always-current update of the status of his card's credit limit, the most recent transactions on said account, as well as other updatable information. Some current methods of obtaining this information include calling a toll free number, using an interactive menu and listening to the information provided in the form of a computerized aural report. Another method is to phone the card issuer and request the desired information. Still another method is to use the Internet to view such account information using passwords that do not offer complete security. The standby method is to wait for the monthly statement. However, none of these approaches are desirable nor always feasible, and furthermore, do not provide immediacy of availability of said information because credit card issuers do not or cannot make instantaneous transactions known to the card holder with all of these methods.

It is desirable to have a system whereby, the card itself bears the relevant instantaneous information (for instance, credit limit available and the last several five transactions) and that information be updated any time changes of said information occurs, or, at predetermined time intervals. It is further desirable to provide communication means between a central data processing center operated by a card issuer and a large plurality of individual cards in the hands of cards' owners. It is also desirable to have a new method of doing business, based on the availability of such updatable cards, whereby, providing this service to card holders with a variety of options and with great ease of usage, would create a marketing advantage as well as an additional source of service revenues to the card issuer. The present invention addresses these needs with a family of “communicating credit cards” as further described below.

The prior art contains a number of examples of smart cards that contains processors and memory device, each with varying end use modalities. The form factor is often similar to the form factor disclosed by Pavelle et al in U.S. Pat. No. 4,096,577 in that the system has the dimensions of a typical credit card, it is physically flexible and it includes a processor and memory. Most of these smart cards, however do not have an independent display that the Pavelle patent does. Hara in U.S. Pat. No. 4,754,418 discloses a credit card calculator that is essentially the '577 patent with the addition of a magnetic strip to allow for storing the card's serial number and other data and allowing these to be read by traditional magnetic credit card readers. However, Hara does not provide for any means to update the credit card account information onto the card.

Roberts et al, in U.S. Pat. No. 5,438,184 describe smart cards that contain integrated circuitry for the purpose of implementing an “electronic purse”. Such a card has a cash value that can be increased (for instance at an ATM) and decreased using a paystation coupled to a transaction terminal for carrying out a transaction between a seller and a buyer using said smart card. However, such a smart card needs to be read and written on, both at the ATM and the said paystation and require additional display and communication links that are exogenous to the card. Furthermore, Robert's smart card is not a credit card but just an electronic currency card.

Fidalgo in U.S. Pat. Nos. 5,690,773 and 5,598,032, as well as Gloton in U.S. Pat. No. 5,767,503 describe a smart card, acting essentially as an “electronic purse”, that includes a processor and an Electrically Erasable Programmable Read Only memory (EEPROM), or flash memory. That card, as well, is designed as an “electronic purse” to carry on debiting and crediting transactions, for instance in paying for telephone calls, or in lieu of tokens in public transportation systems and even as means of paying for games or other transactions. These cards can be inserted in a terminal at the point of sales that interfaces with the card's processor and memory to decrease or increase the monetary value stored on the card.

These cards can also be used in a contact-less fashion, namely, in lieu of having to insert a card into a reader to establish an interface between the card and the reader, the card is passed over a reader (writer), and the information is transferred between the reader and the card inductively. The reader is a plate including an element (a coil or a single ring) powered by an alternating current at a predetermined frequency, and thus creating an alternating magnetic field that induces an EMF on a fine solenoid embedded within the card.

An example of such a smart card is the GemEasy 8000 card from the GemPlus company. The information transferred from the reader to the card is simply in the form of amplitude modulation of the alternating current, and to the extent that there is a need to transfer data from the card to the reader, load modulation of the card is used. The power to drive the card's circuitry is derived from the inductive coupling between the card and the reader (typically, the solenoid is discharged into a capacitor on the card whose charge is then used to power the card's circuitry). Such contact-less “electronic purses” have no independent power source, the distance between the reader and the card during the interaction between the card and the reader cannot exceed about 10 cm, nor does the card possess a display, not does it have any means of user readable information stored thereon and the card itself is not acting as a general purpose credit card.

Jun et al in U.S. Pat. No. 5,828,044 describe another type of non-contacting radiofrequency recognizing credit card system. This system is designed to avoid the need to physically run the card through and in contact with a magnetic card reader. This system involves a terminal, in proximity of the card, transmitting a short range radio signal that is captured inductively by a coil within the credit card, and then the card's number or ID is reradiated for the terminal to read and compare to existing lists of “black/listed” numbers. As above, the power to operate the integrated circuit within the card is provided by the voltage induced on the card's coil by the terminal's radio-frequency signal. The typical distance of operation between the terminal and the card is 10 cm or less as above. The card itself has no battery nor display, nor can the card provide updating of credit information of the specific account of the card holder.

Houdeau et al in U.S. Pat. No. 5,896,111 describe an embedded flat coiled antenna (essentially a concentric polygon) for contact-less smart cards. The flat coil is designed, as in the aforementioned applications, to power the smart card integrated circuit, as well as for very short range interaction with a reader in a contact-less fashion.

Schilling in U.S. Pat. Nos. 5,359,182 and 6,003,770, describes a wireless telephone debit system, said wireless system having an independent RF network. The debit card used in conjunction with such a wireless systems has the general format of traditional credit cards, and in some embodiments contains, like in Pavelle et al's U.S. Pat. No. 4,096,577, an electronic processor and electronic memory. Schilling's card, however, must be inserted into a card reader's slot, said reader being part of an independent radio telecommunication device so as to read from the card or write on the card desired data and remaining credit information. This makes this system cumbersome, in that a user must carry a card reader, or at least a wireless telephone with a card reader. Furthermore, in Schilling's wireless systems, the debit cards can be used only to debit the cost of the telephone calls carried out within the wireless system.

There is therefore a need for an all purpose credit card system in which the electronic credit cards can communicate directly with the wireless system rather than through a card reader, and can be used in all transactions currently enabled by traditional credit cards.

There is furthermore, a need to provide a wireless communication system and methods of efficiently communicating in said systems between a central data processing center and a large plurality of cards in card's holder's possession.

Furthermore, the prior art is completely devoid of methods of doing business based on providing instant information to a group of card holders relative to the card's account credit limits and most recent transactions, except through query by telephone through a cumbersome computer led dialogue, or on a monthly basis through the hard copy account summary and through Internet accounts. There is therefore a need for a method of doing business involving providing a unique service, and possibly a premium service, to card holders, whereby the card they hold is automatically updated with instantaneous account information, either at predetermined times, or on demand by the card holder.

### OBJECTS OF THE INVENTION

Accordingly, it is the main object of the present invention to provide a communicating credit card (CCC) and a wireless communication system within which said card operates.

It is another object of the invention to provide a CCC in which the CCC operates in a “receive only” mode.

It is another object of the present invention to provide a CCC whereby the communication link allows for the CCC's bearer to query the wireless system at will for data related to the CCC's account and recent transactions.

It is yet another object of the present invention to provide power saving communication algorithms controlling the communication of the CCC with its wireless communication system so as to preserve battery life in said CCC. It is another object of the present invention to provide a message structure used in said communication that assures time synchronism between the central data processing system of the wireless network and all cards in the hands of card holders. It is yet another object of the invention to provide such a CCC that can alternatively interface with other communication devices, such as a personal computer connected to the internet, portable wireless communication devices as well as personal data assistants or palm computers.

It is a further object of the invention to create a new method of doing business based on providing a unique service to customers, whereby each customer is provided with means yielding a user readable record of the updated status of his credit limit and a record of the most recent transactions carried out in the account, even when more than one CCC is used in conjunction with a single CCC account.

### SUMMARY OF THE INVENTION

To achieve the stated objectives, a smart credit card is provided with integrated circuitry that includes a thin, possibly printed antenna, a receiver, a processor, flash memory (EEPROM) to store a minimal operating program and data, an (alpha) numeric display and a thin format battery. The processor is further provided with an internal clock and an EEPROM embedded algorithm that is designed to turn the power on to most of the integrated circuitry and display only at predetermined time intervals, or on specific command from the CCC bearer. Thus, only the very low power consumption clock is powered at any time. The algorithm controlling the processor also includes a clock resetting function from a time stamp provided within the last message transmitted by the wireless system and received by the CCC from time to time as explained in more detail below. The CCC of the instant invention will have a typical “life” congruent with traditional credit cards that is about two years (most credit cards providers automatically replace the cards every two years.)

In some embodiments of the invention, the receiver is replaced with a transceiver and a rechargeable battery or an energy harvesting system is provided, as described further below, to allow for the higher energy requirement to operate such a transmit/receive type of CCC.

In yet other embodiments of the invention, the CCC is provided with edge contacts either according to established ISO standards or specifically designed for said CCC and an external device.

In yet another embodiment of the invention, a method of doing business is provided, whereby a new service consisting of making available to credit cards users on their own CCC and displayable on said CCC, important and updated data related to their CCC account.

The wireless communication system employed by the CCC can be any of the current or future wireless services available, such as paging networks, cellular phone networks, satellite wireless networks or even wireless internet networks.

Combination of networks, namely, the use of an existing communication backbone to transmit information to remote broadcasters, and then, local retransmission of the data to CCC's in a limited geography through side bands or other lightly used band width of existing public broadcasting systems, such as TV broadcasters (over the air) is contemplated as well. More particularly, a financial transmission method according to the invention can comprise the steps of:

issuing to a multiplicity of individuals respective smart cards each having a credit-card format allowing insertion of the smart card into an automatic teller machine, a machine for charging purchases or services against the smart card or an account of the individual in possession of the smart card, or a device for recording a credit or debit transaction;

providing each smart card with a magnetic strip carrying recorded data identifying an individual to whom the smart card has been issued or an account to which the smart card has been assigned and optionally providing the card with raised indicia identifying the smart card for enabling an impression to be taken therefrom, the smart card further comprising an antenna embedded in the smart card for wireless radiofrequency communication therewith, receiver/transceiver circuitry connected with the antenna and embedded in the smart card, a processor and associated memory embedded in the smart card and connected to the receiver circuitry for processing data communicated to the smart card and updatable as to status, and a display embedded in the smart card and displaying information stored in the memory and transmitted to the smart card through the antenna and the receiver, and a self-generating power source incorporated within the smart card and powering the circuitry, the memory and the display; and

transmitting wirelessly to the smart cards at least intermittently by radiofrequency and from a remote source other than a card reader, account status information at least partly visible on the display and smart card validation information.

Advantageously, and when the card is provided with a transceiver, the method also comprises the step of transmitting a wireless interrogation signal from a respective smart card to a central station and thereby initiating transmission from the central station to the transmitting smart card of data related to an account assigned to the respective smart card and transactions in the respective account.

The smart cards can communicate wirelessly with a central station, either directly or through wireless communication as substations which in turn can be connected by wireless to the central station or can be hard-wired to the central station so that the wireless or radiofrequency signal passes between the substation and the smart card. The smart cards are synchronized by the specially designed four or five-part message further described below.

According to a feature of the invention at least one further device is provided to receive data from and transmit data to a respective smart card, such device including a terminal connected to the internet, such as a desk-top computer, a personal computer which may or may not be connectable to the internet, a personal data assistant or a palm computer.

The data transmitted to the smart card can include an up-dated status of an account servicing a plurality of smart cards. The data transmitted to the smart card can include a series of transmissions in an account servicing a plurality of smart cards.

The smart cards are programmed to minimize electric power utilization between listening time intervals by keeping only its clock powered, and powering the rest of the circuitry only at predetermined time intervals, the listening time interval.

The remote source which transmits the wireless transmission to the smart cards can be a dedicated source. Alternatively the wireless transmission from the remote source to the smart card can be a transmission during intervals in transmissions from a broadcast source to other than smart card users.

According to a feature of the invention the smart cards can themselves generate audible signals in response to information transmitted thereto.

According to a feature of the invention data is accumulated as to interrogation of the central station and the subscriber is then charged a premium price for updating smart cards by such interrogation.

The financial transmission system can comprise:

a multiplicity of smart cards issued to respective individuals, each of the smart cards having a credit-card format allowing insertion of the smart card into an automatic teller machine, a machine for charging purchases or services against the smart card or an account of the individual in possession of the smart card, each smart card having, optionally, raised indicia identifying the smart card for enabling an impression to be taken therefrom, and each card being provided with a magnetic strip carrying recorded data identifying an individual to whom the smart card has been issued or an account to which the smart card has been assigned, each of the smart cards further comprising an antenna embedded in the smart card for wireless radiofrequency communication therewith, receiver/transceiver circuitry including a processor connected with the antenna and embedded in the smart card for processing data communicated to the smart card, a memory embedded in the smart card and connected to the receiver circuitry and updatable as to status, and a display embedded in the smart card and displaying information stored in the memory and transmitted to the smart card through the antenna and the receiver, and a self-generating power source incorporated within the smart card and powering the circuitry, the memory and the display; and

a central station provided with a radiofrequency transmitter for transmitting wirelessly to the smart cards at least intermittently and from a remote location other than a card reader, account status information at least partly visible on the display.

Finally, the invention is a smart card for such financial transmission which comprises a plastic body with a credit-card format allowing insertion of the smart card into an automatic teller machine, a machine for charging purchases or services against the smart card or an account of the individual in possession of the smart card, the smart card may have raised indicia identifying the smart card for enabling an impression to be taken therefrom, and is being provided with a magnetic strip carrying recorded data identifying an individual to whom the smart card has been issued or an account to which the smart card has been assigned, each of the smart cards further comprising an antenna embedded in the smart card for wireless radiofrequency communication therewith, receiver circuitry including a processor connected with the antenna and embedded in the smart card for processing data communicated to the smart card, a memory embedded in the smart card and connected to the receiver circuitry and updatable as to status, a display embedded in the smart card and displaying information stored in the memory and transmitted to the smart card through the antenna and the receiver, and a self-generating power source incorporated within the smart card and powering the circuitry, the memory and the display.

### BRIEF DESCRIPTION OF THE DRAWING

The various features of novelty that characterize the present invention are pointed out with particularity in the claims annexed to and forming part of the disclosure. For a better understanding of the invention, its operating advantages and specific objects attained by its use, reference is made to the accompanying drawings and descriptive matter in which preferred embodiments of the invention are illustrated.

FIG. 1 is a schematic description of the integrated circuitry driving the CCC of the present invention;

FIGS. 2A and 2C depict the front side and back side of a CCC of the instant invention, while FIG. 2B shows the layout of the circuit components in the card;

FIG. 3A and 3B depict the front side and the back side of another embodiment of the present invention;

FIG. 4 depicts a typical message sent from the credit card provider “central station” to each CCC in the field; and

FIG. 5 is a schematic algorithm used in conjunction with each communication at each CCC in a network.

### DESCRIPTION OF PREFERRED EMBODIMENTS

To achieve the stated objects and other objects that will become apparent, a smart communicating credit card (CCC) of the present invention is provided with an integrated circuitry as further detailed herein, a thin antenna embedded, printed or deposited on the CCC, a flat thin battery and a numeric or alpha numeric display.

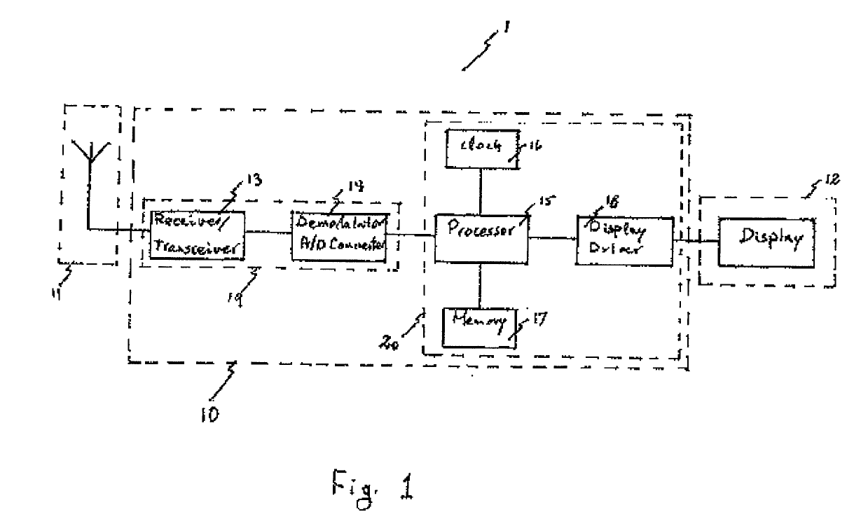

A general schematic depiction of a basic circuitry that can be used to operate a CCC is shown in FIG. 1. Specifically, the CCC's circuitry 1 consists of three major elements, an integrated circuit (IC), 10, a “printed” antenna, 11 and a display module 12.

The IC typically contains a receiver (and in some embodiments, a transceiver), 13, a demodulator and analog to digital converter (A/D converter) unit, 14. The IC also contains a processor that is interfaced with a clock, 16, memory means 17 and a display driver module 18. It should be clear that the receiver circuitry includes a resonant circuit tuned to the wireless system frequency as well as appropriate amplification means.

In some embodiments of the invention, the IC, 10, is physically divided into two sub-IC's, 19 and 20. The first, sub-IC, 19, contains the analog part of the circuitry, 1. It consists of two sub-modules, the receiver/transceiver circuitry that itself will typically include a resonant circuit tuned to the wireless system's frequency and a RF amplifier. The second module contains a demodulator and an A/D converter. The second sub-IC, 20, the digital parts of the circuitry, 1, comprises four sub-modules, namely, a processor, 15, that can have a small “scratch pad” random access (RAM) memory, a flash memory, 17, such as an EEPROM, a clock, 16 and a display driver, 18.

The IC, 10 or the two IC's 19 and 20 can be made in a manner similar to IC used in smart cards of the prior art so as to fit the form factor standardized in the market place. It should be clear, however, that as the nascent technology of polymeric electronic devices develops to the stage of miniaturization reached by silicon based ICs, ICs implemented from such polymer based devices could be used in conjunction with the present invention.

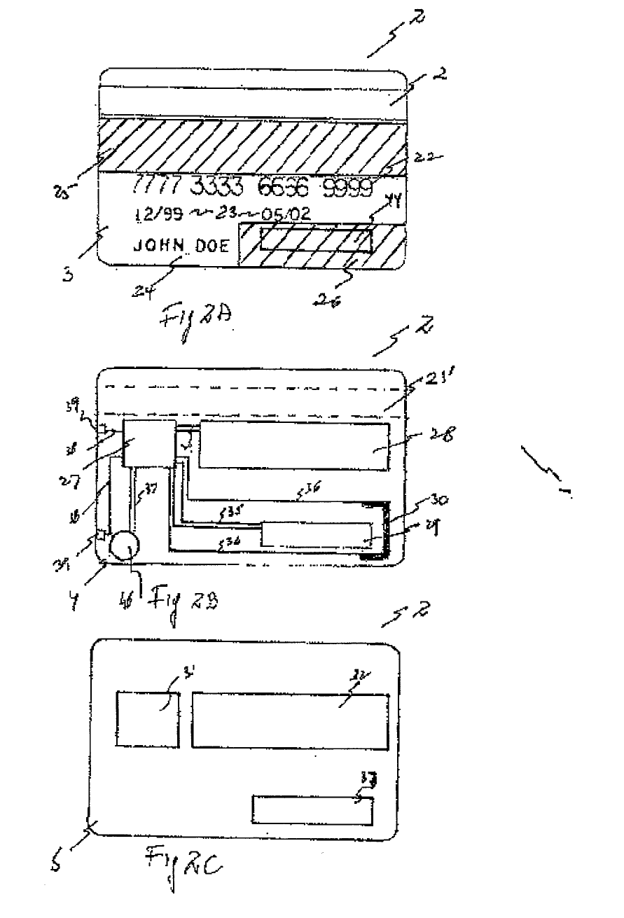

In FIG. 2A is shown the front side of a typical credit card, 2. The card is typically made from a plastic material and is about 0.0301″ in thickness. The length of the plastic card is 85 mm (3.375″) and its width 54 mm (2.125″). The location of the magnetic strip, 21, is an industry standard (about 5 mm from the card's top) as well as it width (about 8 mm), so that all magnetic card readers at any point of sales can read cards from a plurality of cards suppliers. Typically, the card will have an embossed 16 digits number, 22, issue and expiration dates, 23 and the card owner's name, 14. These embossments are allocated specific locations on the card, that are also industry standards, so as to allow the card to be used with older point of sales equipment, where an impression of these three data lines is taken.

In order to allow for back compatibility of a new card system with the existing infrastructure of card reading equipment in the field, it is important to keep the unique features, 21, 22, 23 and 24, at the same locations on any new card introduced into the market place. Thus in most embodiments of the present invention, the space now not occupied by these four features, specifically, the hatched areas, 25 and 26 is used to mount the circuitry described in FIG. 1.

Typically, the CCC is made from three elements, a body, or a frame, about 0.024″ thick and two laminates, about 0.003″ thick. The can be produced from of an appropriate polymer from one or more monomers. For example, acryonitrile-butadiene-styrene (ABS), polyvinyl chloride (PVC), polyethylene terphthalate (PET), and for transparent parts one can use optically transparent versions of polycarbonate (PC) and polymethyl methacrylate (PMMA). The laminates can also be made from Mylar or polyaramid as is the practice in the manufacture of flexible printed circuits.

FIG. 2A, the front side of the CC also represents the “front laminate”, 3, on which the magnetic strip, 21, is present.

In FIG. 2B we show the back laminate, 4, of the CCC, 2, with the various circuit elements mounted thereon. Specifically, the IC, 27, the battery, 28 and the display, 29. These three elements are about 0.020″ to 0.024″ in thickness. It should be noted that the active elements (the IC, the battery and the display) are positioned within the projection of the areas 25 and 26 in FIG. 2A, those areas where no embossments or magnetic strip are present. The projection, 21′, of the magnetic strip 21 on the plane of the laminate 4, is shown for dimensional reference only.

In FIG. 2C is depicted the flexible “frame” of the CCC to which laminates 3 and 4 are laminated thereto. The frame 5 is about 0.024″ thick and has three main perforations, 31, 32 and 33 into which the IC, 27, the battery, 28 and the display, 29 fit, respectively, with good clearance, namely the respective dimensions of these perforations are slightly larger than the external dimensions of their mating elements.

Referring again to FIG. 2B, an antenna, 30, is provided in the form of a printed metallization. It should be understood that this antenna can take any of a variety of shapes, depending mostly on the frequency at which the host wireless system operate. The antenna depicted in FIG. 2B, for instance, would be useful for systems operating in some pager systems operating around 950 MHz. In some embodiments of the invention, the antenna can occupy most the area of the laminate, 4, and is actually embedded within the laminate, as further detailed below.

Referring further to FIG. 2B, a variety of leads and interconnections are provided in the form of thin metallization on the laminate, 4. For example, the leads, 34, provide for connecting the battery, 28, to the IC, 27. The leads, 35, provide for connections between the display element, 29 and its driver within the IC, 27. Similarly, the antenna, 30, is connected to the RF receiver within the IC, 27, with leads 36. Optional external contacts, 39, are connected to the IC, 27, with metallized connections, 38. In a similar manner, an activating membrane switch, 46, whose function is further detailed below, is connected to the IC, 27, with leads 37.

The manner of patterning the desired metallization on the laminate, 4, is well known in the prior art, particularly, the art of making flexible printed circuits. A plurality of technologies can be used. For instance, the pattern can first be printed through a mask, or a silk screen with a sensitizing agent, followed by electroless deposition of copper or nickel, that is deposited from the electrolyte solution selectively on the pre-sensitized area. Another technique that can be used is the flash evaporation (in vacuum) of aluminum through an appropriate mask, as practiced in the semiconductor industry. Yet another approach is etching back through a mask the undesired metallization from a laminate that was fully metallized prior to the process. It should be clear that the metallization also provides for appropriate contact pads (not shown, under the IC and the display) so as to surface mount the active elements to the laminate, 4.

Assembly of the card is typically carried on in the following manner. First, the laminate, 4 is patterned, then the active elements and the battery are surface mounted thereon. The next step involves laminating the laminate 4, onto the frame, 5, a process that can be highly automated using indexing robots, and then the laminate 3 is affixed to the top surface of the frame. Appropriate adhesives, such as cyanoacrylates, or pressure sensitive adhesives can be used in the laminating process.

As alluded to above, the present invention provides for two types of CCC's and thus two different types of services. The first type involves only receiving data from the service provider at predetermined times, but accessing the data (now stored on the CCC) at any time by the card holder. A second type of CCC allows the user to query the service provider for the data desired at any time, and of course, access these data, between such queries, at any time.

Thus in one of the embodiments of the present invention, the CCC is provided with a narrow bandwidth RF receiver (“dumb receiver”), that allows only reception of RF signals carrying the desired data. We term this embodiment of the invention a “Receive Only” CCC (RO-CCC). Such an RO-CCC has a simpler IC to allow reception and conversion of the radio signals to digital signals, carry on limited data processing functions in its processor (that also has a small local scratch pad RAM memory), power the display's driver, and a small resident non-volatile memory, typically in the form of a flash memory element such as an EEPROM. This RO-CCC also has its standard magnetic strip as in traditional credit cards to allow card identification by traditional magnetic means at points of sales in the field.

The battery, 32, used in conjunction with the RO-CCC can be for instance, a custom made battery from Power Paper Ltd (Israel) having a capacity of about 15 mAhr. Its dimensions are 0.020″×0.5″×2″, fitting well within the space 32 (see FIG. 2C) provided within the frame 5. As will be seen below, the RO-CCC processor and receiver circuits are “on” for only very short periods of times few times a day. The stand by current during the expected life of the CCC (about 700 days) is about 0.5 micro-amperes, sufficient to run the clock only. This should require about 8.4 mAhr. We expect the RO-CCC's main IC to be switched “On” about 4 to 10 times daily, for no more than 2 seconds (and quite possibly much less) at a current of up to 0.1 mA, or at most for a total life time of less than 4 hours, requiring less than 0.5 mAhr. These two functions require all together about 9 mAhr. The additional 6 mAhr stored energy in the battery is sufficient to provide power to redisplay the data on the CCC whenever the bearer so desires. The Power Paper Ltd battery is completely flexible and very suitable for this embodiment of the invention.

An alternative battery is a custom made Li-ion battery, about 0.024″×0.5″×2″ from Ultralife Batteries, Inc. having a storage capacity in excess of 22 mAhr. It is not as flexible as the Power Paper's battery but flexible enough for the proposed CCC.

It should be obvious that due to the limited power resources available in the very thin battery embedded within the RO-CCC, it is important to minimize the power drainage on the RO-CCC. To that end, a number of reception timing approaches can be conceived to minimize the number of “hook ups” between the CCC and the central data processing communicator, and thus minimize load on the battery. One such timing algorithm is further detailed below.

In order to reduce drainage of the CCC's battery, the CCC is in a dormant state until the CCC data provider broadcasts a message carrying updated data directed to the specific CCC. It should be quite obvious that the shorter the intervals during which the receiver and processor on the CCC must be operational, the longer will be the CCC's battery life. The actual transmission time of a message, at slow rates of 10 kbytes per second, that as we will see below need be no more than 256 bytes, is a fraction of a millisecond. However, it is extremely difficult to keep an electronic clock accurate over long periods of times, and certainly not to within few milliseconds. Thus, an integral part of the present invention includes means to keep the clock within each CCC in synchronism with the wireless system's clock within which the CCC operates.

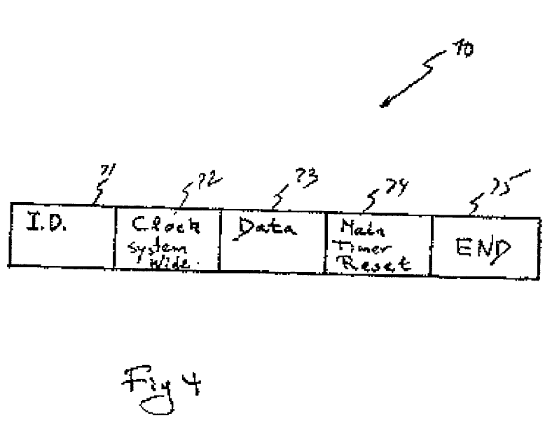

To optimize battery utilization, a unique message, 70, in FIG. 4, containing therein means to synchronize the CCC's clock with the CCC's service provider “master clock”, is used when data are transmitted from the wireless system to the CCC. The message, 70, includes at least four segments, a header 71, that is the unique identifier of the CCC to which the data are targeted, typically an 8 byte string. A time stamp or clock signal, 72, that is incorporated into the message by the central transmitter at the time of transmission, typically an 8 byte string as well. The third segment, the data stream segment, 73, may have a string as long as 216 bytes. The last segment, the termination or “End” of the message, 75, includes in a “check sum” string against which the whole message is checked at the receiving end (the CCC) to assure that the whole message was received without data corruption.

In some embodiments of the invention, an additional segment, 74, may also bear information related to the next scheduled transmission, as further explained below, and it would typically be a string of 8 bytes as well. Thus the whole message will be typically only 256 bytes long. Each of these segments is long enough for most expected purposes, and the whole message could be easily contracted if so desired.

To provide for secure transmission, an ingrained encryption is provided. While many encryption algorithms are available, we find that a check sum match between a two digit number, at the end of each of the four segments, and the CCC residing sets of four two digits numbers (corresponding to those end segments numbers) is sufficient in conjunction with the CCC's unique ID (typically a 16 digit number) to provide the necessary security of the data transmitted.

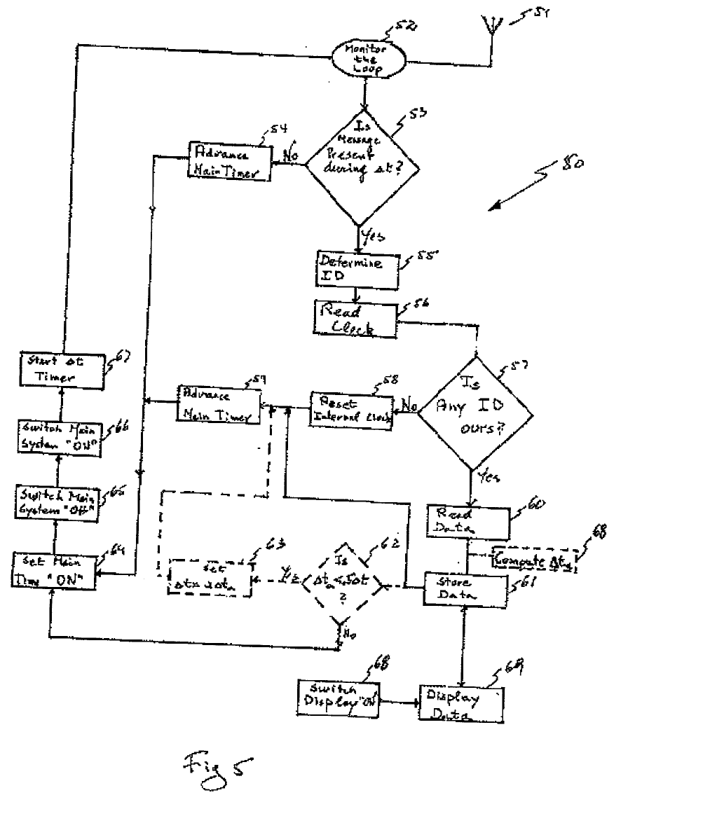

In FIG. 5, we show an algorithm, 50, that can be used in conjunction with the message, 70, broadcast over the wireless system. Once the CCC is turned on, the signal received from antenna, 51, is monitored at 52 (monitor the loop). At decision box, 53, the system determines if any messages are present during the time interval, Dt, the “listening time interval”. The interval Dt, is predetermined initially, when the CCC is initialized at the CCC's provider facility, and in some embodiments of the invention, it can be shortened through an optional algorithm discussed further below. Initial setting for Dt would typically be in the range of 1 to 3 seconds. If there is no “message” present during the interval Dt, then the decision box, 53, selects “No” and advances the “Main Timer” at box, 54. The “Main Timer” counts a time interval between listening intervals. Advancing the Main Timer simply sets up a counter on the CCC residing clock to determine the time interval between listening periods. This interval is typically between 1 to 4 hours. From box 54, the system goes all the way to box, 64, where the “Main Timer” is started, then the system switches off all parts of the IC except it's internal clock at box 65. Once that main time interval has lapsed, the system is switched back “ON” at box 66, and a Dt timer is started. This activates the receiver for a period Dt at box 52, to restart monitoring the loop.

A “No” decision at decision box 53, would typically mean that the CCC's bearer is outside the range of the broadcasting center and thus cannot receive the then scheduled transmission. There might, of course be exogenous reasons for no broadcast as well, such as problems with the wireless broadcasting system itself. By advancing the “Main Timer” at box 54 by one period, the CCC becomes ready to accept the next attempt of communication between the loop and the CCC.

If any message is present at decision box, 53, during the short listening period Dt, the system selects “Yes” at that decision box and goes to execution box 55, where the ID, 71 (FIG. 4), is determined from each of the many messages, 70, received during the listening period Dt. The IC logic in the CCC reads only the two first segments of each message, the ID and the master clock signature, or the system wide clock, 72 in FIG. 4.

That system wide time stamp is read at box 56 (and stored temporarily on a ram scratch pad with other data read).

It should be understood that many messages are received sequentially at 52, but only a few of these messages will carry the ID associated with the specific CCC receiving these messages. For redundancy purposes, a few duplicates of the same message may be sent by the central data processing unit during a “listening time interval”. Typically such redundant sending of the same message is limited to about three, but some practitioners of the present invention may choose to vary that number from 1 to as many as 10 repetitions.

At decision box, 57, the system determines if any of the messages, ID is indeed, the CCC's ID (“ID Ours?”). If none of the messages received bore in segment 71, the local CCC's ID, “No” is selected at decision box 57, and the system uses the just received time stamp from the system to update, or reset, its own internal clock at execution box 58. Thus, the internal clock can be updated even if the appropriate message for the CCC was not received (from other messages received during the listening time interval Dt.) It should be recognized that this update of the local clock on each of the CCC's in the system synchronizes the various CCC's to the master clock in the data provider's wireless network. After resetting the local clock at box 57, the Main Timer is advanced at box 59 and the system goes as above to box 64 to set the Main Timer on, switch the system off (at 65) (except for the internal clock), for a time interval determined by the Main Timer. Once the time interval between listening periods has lapsed, the system is “awakened”, at 66 and the listening period timer at 67 is started for a period Dt, as before.

If, however, at decision box 57, it is determined that one of the messages received during the interval Dt had an ID matching the CCC's ID, “Yes” is selected at 57, and the whole message is read at 60. It should be understood that at box 60, the message received is authenticated (namely, internal and total check sums are checked). This is then followed at box 61 by storing pertinent data on the non-volatile memory (Flash memory or EEPROM memory 17, in FIG. 1). From this point on, the system goes back to box 59, to prepare the CCC for the next listening cycle as described above.

If at any time (between listening periods) the CCC user wishes to review the most recent data received, he can press a small membrane switch on the card (46, in FIG. 2B), thus activating the display function at box 69, that then fetches the data from the EEPROM 17 (FIG. 1), stored there earlier in box 61, and display these data in a sequential manner on the CCC's display, 29 (FIG. 2B).

In some embodiments of the invention, is may be desirable to further minimize the time interval Dt in a heuristic manner, namely from the experience gathered by the CCC in prior receptions of signals from the loop. A number of heuristic algorithms can be used for that purpose, and one such optional algorithm is shown as part of FIG. 4.

Specifically, after a successful recognition of a message bearing the CCC's ID is completed at selection box 57, and the data in message 70 are read by the processor, a time interval, Dta, is calculated at an optional execution box, 68. Dta is the time lapsed between the initiation of the listening cycle and the reception of a first message bearing the CCC's ID that was successfully deciphered, namely the final check sum indicated that the message was not corrupted. In some embodiments, to assure that the listening time is not set too short by the algorithm, Dta is chosen to be the maximum between a fixed very short time interval (for instance, between 10 to 50 milliseconds) and the actual time lapse between reception and recognition of a valid message bearing the CCC's ID. After the system stores the data received in the EEPROM at execution box 61, the system goes to an additional optional decision box 62, where the actual time interval, Dta, is compared to the then stored listening interval, Dt, in this case, determining if Dta is smaller than half the set listening time interval. If it is not, then the listening interval is optimized. If, however, the actual time interval for receipt of a message bearing the CCC's ID is less than half the preset listening interval, then the listening interval is set to twice the actual time interval, at box 63 and the system returns to box 59 to prepare the system for the next listening period.

It should be clear that other measures rather than “half” could be used in this sub-algorithm, but we find that the system is more stable when the received message with the correct ID is more or less in the middle of the listening interval).

The Dt optimization process is particularly important when a new card is put in service, since a relatively large listening interval may be preset initially, to accommodate variations of reception in the field as well as differences in the quality of the synchronization system.

In some embodiments of the invention, the listening interval is increased when an event of failing to receive a message bearing the CCC's ID, at the decision box, 57, has occurred. In other embodiments of the invention, the listening interval is variable up to a preset upper limit, and once a message with the appropriate ID is received, an algorithm directing the CCC to shut off the receiver first. Then after completing the storing the pertinent data onto the EEPROM is carried out, the rest of the IC is shut off, except, of course, the CCC's internal clock.

In yet another embodiment of the invention, the RO-CCC clock's fixed time interval elapsed between sequential transmissions (Main Timer) can be updated on every reception directed to it from the system. This is achieved by using segment 74 of the message 70 (see FIG. 4) to provide for a “Main Timer” reset value dictated centrally by the CCC's provider.

Initialization of the CCC can be carried out in a variety of forms. The simplest is to initialize the CCC prior to shipment to the user. That will involve writing onto the EEPROM the CCC unique ID and initial timing parameters (also known as default timing parameters). During the initialization, the small software program that operates the processor on the CCC, namely its operating system is written to the same EEPROM unit as well. During shipment, the CCC may “wake up” and the preset time intervals initialized and simply not receive any transmission. In other embodiments of the invention, one may also provide the prospective user of the CCC with a toll free number to call in and certify that he has received his new CCC and thus activate the broadcasting of signals from that time on. One could also activate the CCC using an Internet account. It should be clear that if one uses as the initial “listening time” Dt, a full “Main Interval”, then, when using the aforementioned listening interval self adjustment routine, the CCC will rapidly reduce to a listening interval to the optimum required for the locale in which the user resides.

In yet other embodiments of the invention, activation of the CCC can be initiated by the CCC's bearer by using the membrane switch, 46, and pressing it until the display shows a special message, such as “Ready”, or a greeting or any other predetermined message that lets the user know that his CCC is now “operational”.

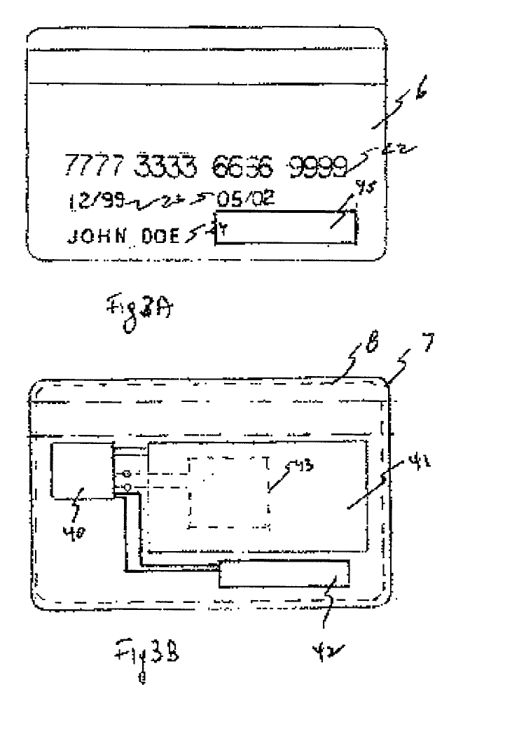

In yet another embodiment of the invention, the CCC is provided with a narrow band transceiver, rather than a “dumb receiver”, allowing the user to query the system at will for data. We term this embodiment a “Receive-Request” CCC, or a RR-CCC. Such a system will require a much more powerful battery, and in some embodiments, a rechargeable battery, since typically, the power required for transmission is of the order of 0.5 Watt, while in the “receive only” mode, the power required is in the microwatts range, and in the dormant state (clock only) much less. To implement an embodiment of the RR-CCC, an area larger than the area provided in FIG. 2B for battery (a part of the embossment free area of the CCC) must be provided for the battery. In FIGS. 3A and 3B we present an embodiment of the invention intended to be used as a RR-CCC.

Specifically, a RR-CCC, 7, consisting as in FIG. 2 of a middle frame about 0.024″ thick, is provided with appropriate windows, and is sandwiched between two laminates, the front laminate, 6, and a back laminate, 8 (only the projection of the back laminate, 8, is shown in FIG. 3B). The active elements, including the IC, 40, the battery, 41 and the display, 42, are mounted on the back laminate, 8, in a fashion similar to that described for the CCC in FIG. 2. The IC, 40, contains, in lieu of a receiver only circuit, as in the RO-CCC, a transceiver capable of both receiving an RF signal and broadcast an RF signal. As above, this IC also contains within its analog section a resonant circuit, a demodulator and an A/D converter. The digital part of the IC is essentially the same as described above. The antenna, 43, is embedded within the back laminate, 8, onto which all the elements are mounted. The battery, 41 is substantially larger than the battery of the RO-CCC and occupies space that would usually be within the projection of the area, 25, in FIG. 2.

The size of the battery used in this embodiment prevents, therefore, the embossment of the card with the information required when the CCC is used in conjunction with a manual type of card reader (non-magnetic and relying only on the embossed information). To alleviate this problem, the laminate, 6 is prepared in a fashion somewhat dissimilar to the accepted practice (that is embossing the finished card).

In one embodiment of the invention, prior to laminating the laminate, 6, onto the frame, 7, the laminate, 6 alone is embossed, with the ID number, 22, the issue and expiration dates of the CCC, 23, and the CCC's bearer's name, 24. Because, the laminate, 6, is very thin (about 0.003″), the backside of the laminate is back-filled (namely the depressions left by the embossment process), with an appropriate curable polymer (that can also serve as the adhesive when affixing the top laminate, 6, onto the frame, 7). In this manner, the embossment is strengthened and is capable of withstanding the multiple reading with manual card readers, and the CCC of the present invention keeps back compatibility with both magnetic and manual readers at points of sales in the field.

In another embodiment of the invention, the embossed data is silk screened with a UV curable polymer, having a high viscosity, and through a screen having a depth of about 0.005″ to 0.007″, in essence replicating the effect of embossment without actually embossing the CCC.

In some embodiments of the invention, the battery of the RR-CCC is not attached to the laminate, 8, as described in FIG. 2, but is insertable in a slot formed in the frame 7, namely, the battery extends to the edge of the card. This allows for replacement of the battery when exhausted.

Since the power requirements for a RR-CCC card are much greater than that of a RO-CCC, it is sometimes advantageous to use a rechargeable battery in lieu of a primary battery. Li-Polymer batteries, from either Ultralife Batteries, Inc. or from Valence Technology, Inc. are appropriate for that purpose. When a rechargeable battery is used, recharging is carried out through flush metallic contacts on the edge of the battery (such as the contacts, 39, shown in FIG. 2B.

Typically, a full transmission and reception will require about 1 to 5 seconds of full transmission time at about 500 milliwatts. The actual time for the communication may be shorter, but there is a need to wait for acknowledgment. Thus each transmission will require about 0.5 mAhr from the rechargeable battery. The typical charge of a 1″×2″×0.024″ is about 50 mAhr, thus allowing for about 100 requests of information between recharging the battery.

In some embodiments of the invention, an energy harvesting system is provided. One such system consists of few small solar cells distributed in various areas of the CCC (this to maintain flexibility), having a total area of about 2 cm². Such solar cells operate at an energy conversion efficiency slightly above 10%. Since each transmission requires about 0.7 milliwatts-hr, a one hour exposure to full sun (10,000 lux) would provide recharging of about 20 milliwatts-hr, while exposure for one hour in a normal (overcast) outdoor light (1000 lux) would provide 2 milliwatts hr. These exposures are sufficient for between 3 and 30 requests (transmissions). When operating in a close environment with normal artificial light (about 200 lux), it will require about two hours of solar recharging between requests of information. Of course, doubling the area of the solar cells to 4 cm² will reduce that time by a factor of 2.

In some embodiments of the invention, the card can be used either in conjunction with a “reader” or in the pure wireless communication mode. In such an embodiment, at least two electrical contacts are provided. In other embodiments eight contacts are provided as per ISO 7816, a standard promulgated by the International Standards Organization.

The ISO 7816 standard defines the specifications of the electrical signals from the reader to the card and any electrical signals from the card to reader. The standard also specifies the location of the electrical contacts on the cards through which such communication is carried out. It should be mentioned that ISO 7816 actually allows for up to eight electrical contacts, despite the fact that specific signals are defined for only five of these contacts. In many embodiments, only two communications contacts are required. In some embodiments of the instant invention, two of the additional free contacts specified in ISO 7816 (for instance, the contacts, 39, mentioned above) can be used to recharge the battery on the card. The standard also stipulates specifications for the power-up, or initialization, procedure that is carried out when a card is first inserted into the reader, and the communication protocol between the reader and the card.

In some embodiments of the invention, the ISO 7816 contacts on the edge of the CCC can be used to create an interface between the RR-CCC and an external communication device, using such an external device to communicate with the service provider's network. Such a device can be a cellular telephone adapted to receive the card at a uniquely designed interface thereon, or special dedicated unit in which the card can be inserted. The form factor of such a unit can take many shapes, including the shape of a pen with a slot in which the card can be inserted via the ISO 7816 interface standard. The advantage of such an additional device is that a larger battery can be included thereon, reducing the need to recharge it too often. A person trained in the art would recognize that the CCC of the invention could easily designed to interface with stationary “connectivity” devices such as personal computers, PDAs, wireless internet devices and satellite communication systems as well.

For both main embodiments of the invention, namely the RO-CCC and RR-CCC, a variety of display systems can be used. Typically, the display is mounted on the laminate 4, or the laminate 8, in FIG. 2B and 3B respectively. Because the display is relatively small, a rigid display can be used, typically a liquid crystal display, just as has been used for years in devices based on Pavelle's U.S. Pat. No. 4,096,577 and Hara's U.S. Pat. No. 4,754,418 disclosures respectively. When a rigid display is used in conjunction with either a RO-CCC or a RR-CCC, an appropriate perforation, 44, in the top laminate, 3 (see FIG. 2A), or 45, in the top laminate 6 (see FIG. 3A), is provided so that the display can be viewed through the perforation. In some embodiments, the top laminates are made of a transparent plastic, such as Mylar, PMMA or Poly-carbonate, and while most of the viewed surface of the laminate is made opaque (by printing a corporate logo or just an opaque ink), a window of transparency is left at the positions 44 and 45 respectively.

If it is desired to have a CCC with greater flexibility and greater immunity to damage to the display from excessive bending of the display, fully flexible displays are available as well. Some of these are based on polymer dispersed liquid crystals (PDLC) technology, where the display is simply a very thin sheet of polymer in which micro-droplets of liquid crystal (LC) are dispersed. Seven or eleven (for alpha-numeric display) segments are used for each digit or letter, respectively, and these are patterned with very thin transparent films of ITO (Indium-Tin Oxide). An opposing film of ITO is used to apply the electrical fields on the thickness of the film. With no electrical field applied, the LC within the droplets are randomly oriented and no visible modulation of reflected light occurs. When an electrical field is applied to a segment, the LC droplets therein become oriented within the field, and thus reflected light from the display bears the imprint of the desired pattern. In this manner letters and digits, and thus the desired information can be displayed. It is sometimes advantageous, when using such a thin flexible display, to mount it directly on the back laminate (for instance, 4 in FIG. 2B) on which all the metallizations for connections are provided, but having the visible display on the opposite side of that laminate (the back side of the CC) rather than having the display visible through the frame and the front laminate. When this approach is taken, it is best to use a transparent material, such as Mylar, so that the display can be viewed through the laminate. Since the flexible display is quite thin (less than the 0.020 to 0.024 thickness of the frame), only a depression, 33 (in FIG. 2C) would be used rather than a full perforation as described before.

There are a number of ways the issuer of the CCC's can establish the communication links with the CCC's in the field. One simple method is simply to use free space in an existing pager system. Another method is to exploit an existing communication network's back bone, including the internet backbone to transmit all the data to local broadcasters. For instance, a local TV broadcaster could lease out to the CCC issuer one or more of their ten Vertical Blanking Interval signals (VBI) on which the issuer could broadcast the data to its local subscribers. Each “line” has the capacity of transmitting at the rate of 10 kbits/sec. It should be easily seen that when broadcasting a single message once every four hours, using a single VBI, more than 500,000 subscribers can receive such messages from a single TV broadcaster.

Customers could subscribe to either local or national services, facilitating the issuer's tasks of broadcasting the data to its customers base. A method of doing business differentiating between these two services, making the nationwide service a premium service could be implemented as well. In such a situation, the issuer would broadcast through national backbones data directed to premium customers, either through a plurality of public air broadcasting stations, or in combination with an existing pager network.

When implementing the RR-CCC embodiment of the invention, the frequency at which the card's transceiver would operate can be any of the frequencies allotted by the FCC for various communications media. Since the transmissions are low data density transmissions (a limited number of numeral strings, from the financial “house” and just acknowledgments messages and data queries from the card), they could be easily accommodated within any of the current cell phone, and wireless Internet allocated spectra.

Updating of RR-CCC can be carried out, for instance, only when a change occurs (either a debit or credit transaction has occurred). This would have the great advantage that the RR-CCC holder will still be in the vicinity of the merchant with whom the transaction occurred, and could easily verify that the entry against his account is correct.

When providing a CCC (of either type), one could easily include a computer interface (as mentioned above) and allow updating the CCC at any time by using an automatic “dial up” to the CCC's provide internet web site, followed by normal “hand shake” transactions, and dumping of the updated data on the individual card.

In yet another embodiment of the invention, in lieu (or in addition to a display), an aural signal is provided by a voice synthesizing chip within the card, and the data desired (for instance, credit limit and last five transactions) would be listened to rather than visualized. This is of particular importance to people that are visually impaired, or when the CCC is used in very poorly lit environment.

An important feature of the present invention is a method of doing business in the credit card market that was heretofore unknown, namely, automatically providing credit cards user with updated information of their respective account. Specifically, this method includes providing each credit card bearer with a CCC, the CCC having means to receive, in a wireless fashion, updates of credit limits in the CCC's bearer's account, as well as additional pertinent information such as a plurality of the most recent transactions that have been completed in the account. This method of doing business can be implemented by providing each credit card holder with a RO-CCC and provide a wireless communication network as described above through which the pertinent information is transmitted to each RO-CCC card in the network. This method is further implemented by providing unique messages transmitted in a wireless system, the message containing at least the unique identifier of the target RO-CCC and a universal system time stamp. In some embodiment of the invention, the message can also contain an update of a plurality of the next few scheduled transmissions.

In some embodiments of the method of providing users with current information on their account, the service is provided only when the bearer is within a reception area of a local broadcaster on public frequencies (such as over the air TV or radio broadcasts), while in other embodiments, the service is provided, typically at a premium nationwide.

In another embodiment of the method of providing credit cards users with current information in their account, the issuer provides the card bearer with a RR-CCC and the CCC is updated automatically in the same fashion as the RO-CCC or the credit card user can request an update at any time. Such a premium service can bear a premium price per each requested update or be provided at a flat rate as well.

Having described certain embodiments of the invention, including various communicating credit cards, various methods of implementing communication protocols as well as various methods of doing business involving providing customers with updated information on their CCC accounts on the CCC itself. It should therefore be understood that the foregoing is only illustrative of the principles of the invention, and that various modifications and additions can be made by those skilled in the art without departing from the spirit and scope of the invention. Accordingly, the appended claims shall not be limited by particular features that have been shown and described, but shall be construed to cover any obvious modification and equivalent thereof.

We claim:

1. A method of doing business in the field of credit cards comprising automatically providing to credit card users updated information on respective user accounts and readable from the respective credit cards.

2. A financial transaction method, comprising the steps of:
issuing to a multiplicity of individuals respective smart cards each having a credit-card format allowing insertion of the smart card into an automatic teller machine, a machine for charging purchases or services against the smart card or an account of the individual in possession of the smart card, or a device for recording a credit or debit transaction;
providing each smart card with a magnetic strip carrying recorded data identifying an individual to whom the smart card has been issued or an account to which the smart card has been assigned, said smart card further comprising an antenna embedded in the smart card for wireless radiofrequency communication therewith, receiver circuitry connected with said antenna and embedded in the smart card, a processor, clock and associated memory embedded in the smart card and connected to said receiver circuitry and updatable as to status, and a display embedded in said smart card and displaying information stored in said memory and transmitted to said smart card through said antenna and said receiver, and a self-generating power source incorporated within the smart card and powering said circuitry, said processor, clock and associated memory and said display; and
transmitting wirelessly to said smart cards at least intermittently by radiofrequency and from a remote source other than a card reader, account status information at least partly visible on said display and smart card validation information.

3. The method defined in claim 2 wherein the card is provided with raised indicia identifying the smart card for enabling an impression to be taken therefrom.

4. The method defined in claim 2 wherein said receiver is a transceiver, further comprising the step of transmitting a wireless interrogation signal from a respective smart card to a central station and thereby initiating transmission from said central station to the transmitting smart card of data related to an account assigned to the respective smart card and transactions in the respective account.

5. The method defined in claim 2 wherein said smart cards communicate wirelessly with a central station, said method further comprising the step of synchronizing all of said smart cards by including in each message transmitted from said central station to said smart cards a time stamp used to update said clock to effect smart card synchronization.

6. The method defined in claim 2, further comprising the step of transmitting data from a respective smart card to at least one further device selected from a terminal connected to the internet, a personal computer, a personal data assistant and a palm computer.

7. The method defined in claim 2 wherein the data transmitted to a smart card is an updated status of an account servicing a plurality of said smart cards.

8. The method defined in claim 2 wherein the data transmitted to a smart card is data representing a series of transactions in an account servicing a plurality of said smart cards.

9. The method defined in claim 4, further comprising the step of minimizing electric power utilization by each smart card by keeping only said clock powered on in a continuous manner and all other circuitry off between listening time intervals.

10. The method defined in claim 9 wherein each smart card recognizes messages destined for the respective smart card during any listening time interval, and minimizes subsequent listening time intervals using said time stamp in each message in conjunction with a timing algorithm embedded therein, and is thereby reactivated for the next minimized listening time interval.

11. The method defined in claim 2 wherein the wireless transmission from said remote source to said smart cards is a transmission from a dedicated source.

12. The method defined in claim 2 wherein the wireless transmission from said remote source to said smart cards is a transmission during intervals in transmissions from a broadcast source to other than smart card users.

13. The method defined in claim 2, further comprising the step of generating in said smart cards audible signals in response to information transmitted to said smart cards.

14. The method defined in claim 3, further comprising the step of accumulating data as to interrogation of said central station and charging a premium price to smart-card holders for updating of smart cards by interrogation of the central station.

15. A financial transaction system comprising:
a multiplicity of smart cards issued to respective individuals, each of said smart cards having a credit-card format allowing insertion of the smart card into an automatic teller machine, a machine for charging purchases or services against the smart card or an account of the individual in possession of the smart card, each smart card being provided with a magnetic strip carrying recorded data identifying an individual to whom the smart card has been issued or an account to which the smart card has been assigned, each of said smart cards further comprising an antenna embedded in the smart card for wireless radiofrequency communication therewith, receiver circuitry including a processor connected with said antenna and embedded in the smart card for processing data commnunicated to the smart card, a memory embedded in the smart card and connected to said receiver circuitry and updatable as to status, and a display embedded in said smart card and displaying information stored in said memory and transmitted to said smart card through said antenna and said receiver, and a self-generating power source incorporated within the smart card and powering said circuitry, said memory and said display; and
a central station provided with a radiofrequency transmitter for transmitting wirelessly to said smart cards at least intermittently and from a remote location other than a card reader, account status information at least partly visible on said display.

16. The system defined in claim 15 wherein the card is provided with raised indicia identifying the smart card for enabling an impression to be taken therefrom.

17. The system defined in claim 15 wherein said smart cards are provided with transceivers for transmitting interrogation signals to said central station for initiating transmission from said central station to the transmitting smart card of data related to an account assigned to the respective smart card and transactions in the respective account.

18. The system defined in claim 15 wherein said station transmits signals coded for the respective smart cards at listening intervals thereof, said smart cards being programmed to receive signals coded for individual smart cards during said listening intervals and being in an energy saving mode between the listening intervals.

19. The system defined in claim 15 wherein each of said smart cards includes a clock and said station transmits a message synchronizing said smart cards and including a header identifying a particular one of said smart cards, a clock signal incorporated into the message at the central station, a data stream, and an end segment including a check-sum string.

20. The system defined in claim 19 wherein each message includes a further segment signaling at least the next scheduled transmission.

21. The system defined in claim 17, further comprising a membrane switch on each card for initiating a transmission therefrom to said central station.

22. The system defined in claim 15, further comprising contacts on each smart card enabling connection of the smart card to external circuitry.

23. The system defined in claim 15, further comprising at least one further device communicating with at least one of the smart cards and selected from a terminal connected to the internet, a personal computer, a personal data assistant and a palm computer.

24. The system defined in claim 15, further comprising a transducer in each smart card for generating in said smart cards audible signals in response to information transmitted to said smart cards.

25. A smart card for financial transactions having a plastic body with a credit-card format allowing insertion of the smart card into an automatic teller machine, a machine for charging purchases or services against the smart card or an account of the individual in possession of the smart card, said smart card having raised indicia identifying the smart card for enabling an impression to be taken therefrom, and being provided with a magnetic strip carrying recorded data identifying an individual to whom the smart card has been issued or an account to which the smart card has been assigned, each of said smart cards further comprising an antenna embedded in the smart card for wireless radiofrequency communication therewith, receiver circuitry including a processor connected with said antenna and embedded in the smart card for processing data communicated to the smart card, a memory embedded in the smart card and connected to said receiver circuitry and updatable as to status, a display embedded in said smart card and displaying information stored in said memory and transmitted to said smart card through said antenna and said receiver, and a self-generating power source incorporated within the smart card and powering said circuitry, said memory and said display.

26. The smart card defined in claim 25, further comprising a transmitter for transmitting interrogation signals to a central station for initiating transmission from said central station to the transmitting smart card of data related to an account assigned to the respective smart card and transactions in the respective account.

27. The smart card defined in claim 26 programmed to receive signals coded for the smart card and enabling the smart card to receive data during a listening interval, said smart card being in an energy saving mode between listening intervals.

28. The smart card defined in claim 25, further comprising a clock and being synchronized with a central station upon receipt of a message including a header identifying a particular smart card, a clock signal incorporated into the message, a data stream, and an end segment including a check-sum string.

29. The smart card defined in claim 25, further comprising a membrane switch on each card for initiating a transmission therefrom to said central station.

30. The smart card defined in claim 25, further comprising contacts enabling connection of the smart card to external circuitry.
